(19) United States
(12) Patent Application Publication
(10) Pub. No.: US 2007/0162384 A1
(43) Pub. Date: Jul. 12, 2007

(54) INFRASTRUCTURE FOR A CONSUMER-COMMERCE INTERFACE PAYMENT INSTRUMENTALITY

(76) Inventor: Juergen Weber, Port Perry, Ontario (CA)

Correspondence Address: BAKER & DANIELS LLP;111 E. WAYNE STREET, SUITE 800, FORT WAYNE, IN, 46802, US

(21) Appl. No.: 11/382,827

(22) Filed: May 11, 2006

(30) Foreign Application Priority Data
Jan. 6, 2006 (CA) 2532385

(51) Int. Cl. G06Q 40/00

(52) U.S. Cl. 705/39

(57) ABSTRACT

A functional infrastructure for a consumer-commerce interface payment instrumentality comprises: a) a financial institution participant; b) an information technology (IT) participant; and c) a card manufacturer/supplier participant; said IT participant interfacing with said financial institution (a) and said card manufacturer/supplier (c) and providing transaction processing thereby providing consumers with a payment means for use in commerce.

The present invention relates to the field of commerce. In particular, the present invention provides a method for the management of payments for retail commencing, including in particular Internet commerce.

There currently exists several secure and fairly simple methods of effecting payment for goods or services that are purchased over the Internet. Most commonly, transactions conducted over the Internet utilize credit cards. However, because of the legitimate concern that some merchants or employees of merchants may not be honest, many persons are reluctant to provide credit card information over the Internet. Moreover, by providing such information to a merchant, the individual must trust the security of the merchants site against hackers. Virtual cash, or e-money, has been proposed by many different sources as a solution to the problem of security of transcations. Under such a system, a person can authorize, on-line, the transfer of money from a bank account to a virtual cash account with service provider. The case in that account is then spent until depleted. That system has the advantage of not exposing large sums of money to risk—assuming that money in a bank and accessible on-line is not at risk, a fairly safe assumption—but nonetheless, an essential element of the system is access to a bank account or credit card account on-line for withdrawal, so some risk is present. Moreover, such a system cannot be used off-line, for instance, at a restaurant or a shop.

Pre-loaded “smart” cards, with tamper-proof observer chips therein, that can accurately keep track of the amount of money loaded on the card are effective for use off-line, but require special apparatus for reading an updating.

Debit cards are not used on-line, since a break down in security would expose the entire contents of a user's account to risk.

Each of the foregoing problems may be addressed by providing a card of the traditional credit card size and shape that can be used off-line like a credit or debit card, and on-line like virtual money. Account information is not maintained on or in the card, but at a banking or other financial institution, where a running balance of money on the card and available to be spent is kept. The card of the present invention is, moreover, completely anonymous, and so is capable of acquisition without proof of identity, and is fully transferable. This type of card is described in Applicant's abandoned application CA2325095.

To acquire and use such a card, a consumer attends at the premises of a bank or other financial institution and purchases, for cash, credit or transfer a card (e.g. an ECOMCARD™) pursuant to the present invention. The card is of either a pre-set value, or any value desired by the consumer, depending on how much is paid for the card. It is also anticipated that the card of the present invention would also be available for purchase at merchants in pre-set or desired amounts, Financial records relating to each card purchased, including the serial number of the card and the value of same, are maintained by the issuing financial institution. The card is preferably provided with a unique multiple digit serial number that identifies a particular account, there being one account for each card, and a personal identification number which may, if desired, be an expiry date (thereby permitting financial institutions to close inactive accounts after a period of time, which would require a holder of an expired card to redeem it at a bank) but may be any identifying string of numbers. The use of two sets of numbers to identify a card prevents a person from fraudulently attempting to use a card number that they are not authorized to use. That is, while anyone can simply make up a multiple digit number, they would not have any way of knowing the personal identifier that went with it. The card is also provided with a conventional magnetic strip for storing data, and an additional multi-digit personal identification number may be included.

The card is then used, in person, in the same manner as a credit card but without the need for a signature, or over the Internet using the serial number and the personal identification number. In either event, no transaction is completed until the seller contacts the card issuer and verifies the balance on the card is sufficient, and a transfer of the appropriate amount is completed. When only a small amount is left on the card, it is brought to a card issuer and redeemed for cash, or used toward the purchase of a new card.

The old card is then destroyed and is not reloaded. This prevents the re-use of old serial numbers, and ensures that information on each account is always current and accurate. A balance of say, $50.00 could not possible actually be $75.00, because once an account is opened by the purchase of a card, money can only ever come out of the account. Moreover, if an unscrupulous merchant should, by learning a serial number and its accompanying personal identity, try to use a card number in an unauthorized way to make a purchase, the most they could steal would be the balance left on the card.

The object of the present invention, then, is to provide an operational context and infrastructure for the use of a card, as described above. In a broad aspect, then, the present invention relates to a functional infrastructure for a consumer-commerce interface payment instrumentality comprising: a) a financial institution participant; b) an information technology (IT) participant; and c) a card manufacturer/supplier participant; said IT participant interfacing with said financial institution (a) and said card manufacturer/supplier (c) and providing transaction processing thereby providing consumers with a payment means for use in commerce.

In such an infrastructure the IT participant preferably comprises electronic transaction processing means, a customer interface department, and a financial institution interface.

Moreover, the IT participant still further comprises database architecture including databases and applications comprising one or more of e-merchant service applications, customer service applications, accounts applications and databases, billings applications and databases, card issuing applications and databases, and security applications and databases.

In drawings that illustrate the present invention by way of example:

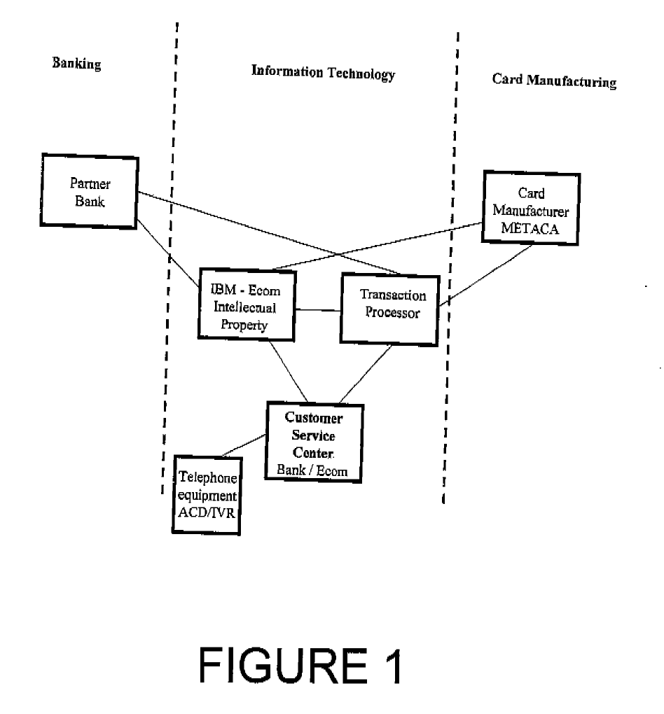

FIG. 1 is a schematic depicting interrelationships of functions in an operational infrastructure according to the present invention;

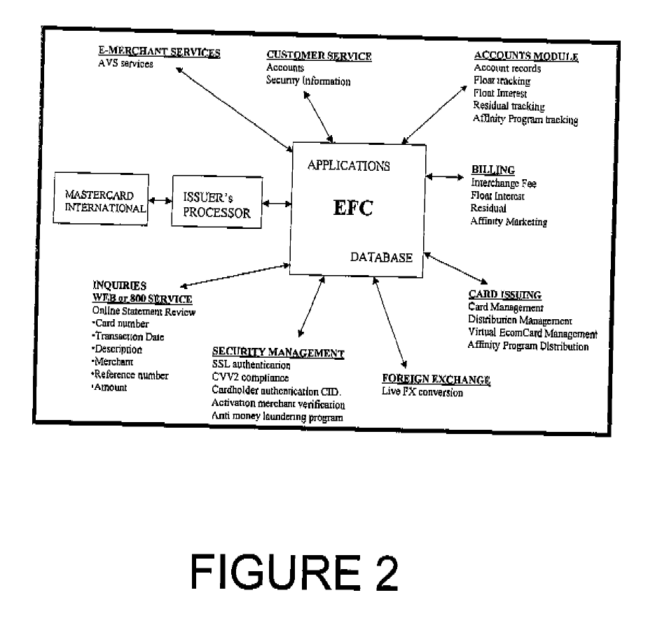

FIG. 2 is a schematic of applications and databases for an operational infrastructure according to the present Invention;

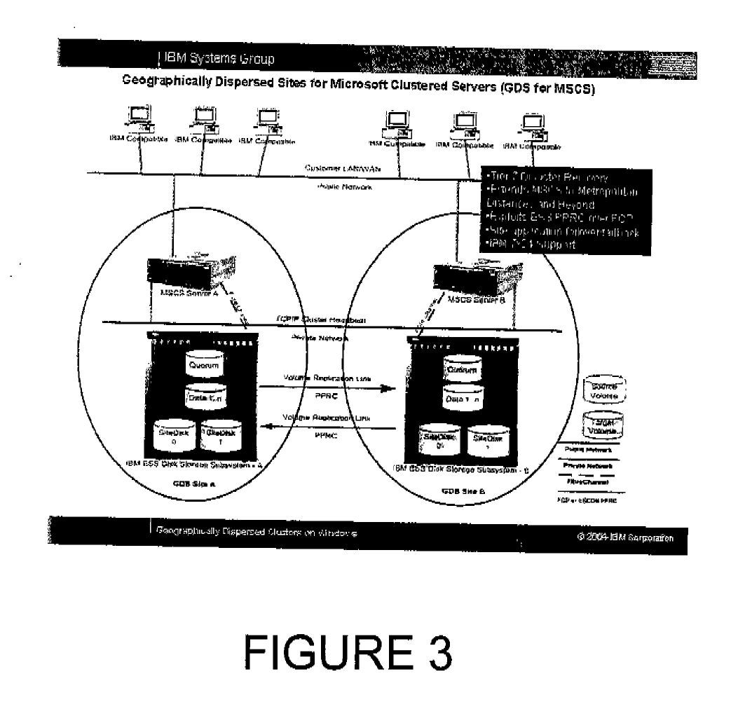

FIG. 3 is a schematic of dispersed server posting and continuity services.

Referring now to the drawings in order to put a card system as described above into effect, an operational infrastructure is required.

From a practical point of view, secure systems are provided that operate around the clock. There is a requirement, then, for a Business Continuity Plan, Disaster Recover Plan, IT Services Plan and Customer Service Center Plan.

Business Operations Plan

The purpose of the business operations plan is to set forth the architecture and process for all key company activities. These activities will include all business functions, such as customer service, banking operations, processing, card manufacturing and technology. Furthermore, this operations plan provides for business continuity in the event of failure or unavailability of one or more sites or processes.

The major components of a card system business can be categorized as follows, and are generally as shown in FIG. 1:
Sales and Marketing
Banking Operations—to be provided by the partner Bank
Customer Service—to be provided either by the partner Bank's existing CSC (“customer service centre”) or by Applicant's CSC, as part of IT
Transaction Processing—to be provided by the partner Bank's processor
Card Manufacturing and Distribution—to be provided by authorized manufacturer
Information Technology—provided in part by the processor and by in part by IBM Global Services™, or other suitable supplier
Near future integration with multiple card processors to adapt systems to display all facets and capabilities of the card
Near future integration of card system within issuing banks and processors to minimize internal system requirements and create universality for loading and issuing of cards globally.
   Banking Operations

The primary function of the bank or other financial institution is to receive funds placed on deposit in trust through the sale of the card, and to manage this trust account based on the trust agreement. The Bank will also receive deposit funds on behalf of the Applicant, which are earned by activation fees, transaction revenue and account management fees upon card expiry. The Bank's additional function is to administer the Applicant's corporate account.

The Applicant's transaction and activation fees will flow directly into the Corporate Account managed by the Bank. The e.g. Visa™/MasterCard™ clearing batch transaction files will be received through Banknet by the processor and by the IBM data centre and will be immediately passed through and deposited into the Bank.

Alternate routing in the event of failure at IBM (e.g.) will be by the designated backup IBM data centre. In the event of a failure of the Bank's information systems, the files will be held until the Bank systems become available or until the Bank redirects the deposits. The Bank will articulate its disaster recovery plan to the Applicant.

Customer Service Centre

The function of the CSC is to receive and process calls from the Applicant's customers regarding card balance, lost cards and balance transfer.

The Applicant functions with the partner Bank to establish two customer service centres located in different cities, One or both of these can be the partner Bank's existing CSC, or it can be a dedicated CSC.

These centres are to be interconnected and also connected to the database servers and web-servers, which will be operated by IBM Global Services at an IBM facility. The centres will also be connected into the processor's facilities, so that “live” accounts may be viewed.

Each CSC may, for instance, handle one half of ail call traffic, but will have sufficient space and communications capability to accommodate all staff from the other centre. ACD and CTI Systems will be rolled out at each centre with the capacity to handle all calls from both centres.

Transaction Processing

The purpose of the transaction process is to process, clear and pay the parties identified in a card transaction—the issuers Visa™/MasterCard™ and the merchant bank.

Transaction processing may be outsourced to a licensed Visa™/MasterCard™ processor. The selection of the processor will be dependent on the preference of the issuing Bank. Should the Bank have no strong preference, the Applicant will select its processor. The processor will have multiple data centres and each centre is connected to Banknet and to Visanet. Should one centre fail, transactions are automatically routed to a designated backup centre. The Applicant's database servers will be connected to both the primary and alternate processing centre.

Card Loading and Activation Systems

These systems are in place to provide the clearing transactions that will load and activate cards. These systems are the Applicant's systems but will be physically located in IBM Global Services data centres. The hardware and operating systems are managed by e.g. IBM and the applications will be maintained independently. The systems will be tied into the processor's transaction server, so that card loading and activation are seamless. IBM's data centres are geographically distributed across North America and fully secured.

Physical servers and computers housing the loading and activation applications are located at a pre-determined IBM Global Services data centre. There will be an exact copy of each system at an alternate IBM Global Services data centre. All systems will be on line at all times, recording loading and activation transactions. Should one system fail or a data centre become unavailable, the alternate centre will continue operations. Upon reinstatement of the tailed system or data centre, the systems will synchronize and continue operations.

Applications may managed from the Applicant's offices by appropriate personnel. Since applications are resident on servers at IBM sites, such staff may work any alternate site with high-speed Internet access if the Applicant's office is unavailable. Appropriate security measures Will be in place, and a VPN is to be utilized.

Facilities Hosting by IBM™

With IBM Facilities Hosting, the Applicant may house its own servers and infrastructure at an IBM e-business Hosting Centre and specify how much control it will retain over its IT design and operation. This infrastructure is the backbone of the Applicant's e-business and IBM's facilities are built with enhanced security features and strict maintenance standards to help protect it.

Each IBM e-business Hosting Centre provides:

Industry-leading operational and security features, including HVAC systems, uninterruptible power supplies and generators, surveillance systems and 24×7 onsite security staff;
High-bandwidth Internet access with “burstable” bandwidth capacity on demand and no single-point-of-network failure;
Around-the-clock monitoring and reporting;
Skilled, onsite technicians;
Superior worldwide customer support 24 hours a day; and
Rapid deployment of the Applicant's hosting solution.
   Database Management Systems

The database systems provide the back office business systems for the Applicant's operations. These systems include customer service databases, account records, float tracking, affinity program tracking, billing, card issuing, foreign exchange and security.

Physical servers and computers housing the databases will be located at a pre-determined IBM Global Services data centre. There will be an exact copy of each system at an alternate IBM Global Services data centre. All systems will be on-line at all times, updating databases as transactions are recorded. Should one system fail or a data centre become unavailable, the alternate centre will continue operations. Upon reinstatement of the failed system or data centre, the systems will synchronize and continue operations.

Database applications, as shown in FIG. 2, are managed from the Applicant's offices by the Applicant's staff. Since databases are resident on servers at IBM sites, the Applicant's staff may work from home if the Applicant's office is unavailable. Appropriate security measures will be in place, and a VPN is to be utilized.

Web Servers

The web servers provide an alternate means for customers to access card balance report lost cards and execute balance transfers.

Web servers may be located at a pre-determined IBM Global Services data centre. There will be an exact copy of each system at an alternate IBM Global Services data centre. All systems will be on-line at all time. Should one system fail or a data centre become unavailable, the alternate centre will continue operations. Upon reinstatement of the failed system or data centre, the systems will synchronize and continue operations.

Web server applications may be managed by appropriate personnel. Since web servers are resident on servers at IBM sites, staff may work from home if desired. Appropriate security measures will be in place, and VPN is to be utilized.

The servers are built as per IBM's geographically dispersed clustered server strategy, shown in FIG. 3.

Card Manufacturing

The Applicant's card manufacturers will be authorized Visa™/MasterCard™ card manufacturers. The Applicant will utilize two or more manufacturers, as predicted volume will be too high for any single manufacturer. This plan also provides for disaster recovery, as the loss of any single manufacturer will not adversely affect operations over the short term.

The disaster recovery capabilities for each card manufacturer will be reviewed and documented on a Financial Information Technology Questionnaire. The Questionnaire is available and has been used to document disaster recovery at Metaca Corporation of Concord, Ontario, Canada.

Critical Suppliers of Services

Therefore, it is understood that critical suppliers of services are listed as:
The partner Bank
Transaction processor
IBM Global Services (e.g.).

Each supplier of services will furnish a disaster recovery plan, and will work to enable a specific disaster recovery process.

We claim:

1. A functional infrastructure for a consumer-commerce interface payment instrumentality comprising:
a) a financial institution participant;
b) an information technology (IT) participant; and
c) a card manufacturer/supplier participant;
said IT participant interfacing with said financial institution (a) and said card manufacturer/supplier (c) and providing transaction processing thereby providing consumers with a payment means for use in commerce.

2. An infrastructure as claimed in claim 1, wherein said IT participant comprises electronic transaction processing means, a customer interface department, and a financial institution interface.

3. An infrastructure as claimed in claim 2, wherein said IT participant further comprises database architecture including databases and applications comprising one or more of e-merchant service applications, customer service applications, accounts applications and databases, billings applications and databases, card issuing applications and databases, and security applications and databases.
